(19) United States
(12) Patent Application Publication
(10) Pub. No.: US 2007/0235099 A1
(43) Pub. Date: Oct. 11, 2007

(54) Sprinkler riser tube and method for making same

(76) Inventor: Chris Okkerse, Saskatoon (CA)

Correspondence Address: FROST BROWN TODD, LLC, 2200 PNC CENTER, 201 E. FIFTH STREET, CINCINNATI, OH, 45202, US

(21) Appl. No.: 11/378,052

(22) Filed: Mar. 17, 2006

(51) Int. Cl. F16L 9/00

(52) U.S. Cl. 138/109; 138/177

(57) ABSTRACT

A riser tube for landscape irrigation is provided by a substantially rigid hollow conduit, threaded at each end for attachment to an irrigation system. The hollow conduit is made by extruding a polycarbonate resin wherein the resin has a property of ductility at low temperatures. The resin may also be stabilized against degradation by ultra-violet light. A suitable resin is Lexan™ EXL 1434 polycarbonate resin.

This invention is in the field of landscape irrigation, and in particular sprinkler riser tubes for use therein.

### BACKGROUND OF THE INVENTION

Landscape irrigation typically utilizes a network of underground supply hoses to supply pressurized water to sprinklers configured to water the landscaped area. In lawn areas, the sprinklers are typically recessed in the ground so that mowers and the like can pass over them unobstructed. A short riser tube typically threads into a T-fitting in the underground hose, and a sprinkler is threaded onto the top end of the riser tube.

Such riser tubes are subject to damage. U.S. Pat. No. 3,952,618 to Seamon, U.S. Pat. No. 5,184,531 to Wickson et al., and U.S. Pat. No. 6,349,624 to Fahringer discuss the problem of removing broken risers from the underground fitting, and disclose tools to facilitate such removal.

In bed areas where higher plants such as shrubs, flowers, and the like are grown the riser tube is connected to the supply hose underground, and extends up above the ground, preferably to a location near the top of the plants in the area. A sprinkler head, typically in the form of an adapter threaded onto the top of the riser and a spray nozzle threaded into the adapter, is connected on the top of the riser tube such that water can be sprayed from the sprinkler head over the plants in the bed. Such taller risers are considerably more prone to damage than the shorter risers used in lawn areas where the sprinkler is recessed in the ground.

The tall riser tube must support the sprinkler head without benefit of being itself supported by the soil and must be sufficiently rigid to remain in the required substantially vertical orientation. The length of the riser tube, typically 2 feet or more above the ground, means that a force exerted laterally at the top of the riser tube exerts considerable leverage at ground level. Landscape personnel conducting maintenance operations in the bed area, such as weeding, pruning, and the like, can easily break the tall riser tubes by contacting them during such operations. Resilient and flexible plastic tubing is available that resists breakage, however such tubing is not sufficiently rigid to maintain the sprinkler head in the required orientation.

Conventional riser tubes are made from polyvinyl chloride (PVC) pipe that is inexpensive to replace as the need arises, however the labor required to replace the riser tubes is typically much more costly than the tube itself. Also in cold climates such conventional PVC riser tubes are very brittle and relatively slight contact by someone walking by will often break the riser tube.

### SUMMARY OF THE INVENTION

It is an object of the present invention to provide a riser tube for landscape irrigation systems that overcomes problems in the prior art.

The present invention provides a riser tube and a method of making a riser tube. A plastic resin is provided that has ductility at low temperatures, and thus does not become brittle when outdoor temperatures drop as low as −40° C. The resin also is stabilized against degradation by ultra-violet light received from sunlight. Such plastics are typically only used in injection molding processes, however the present inventor has found that same can be extruded successfully to provide a relatively inexpensive process for making sections of tubing 10 feet long which can be cut and threaded to make riser tubes in virtually any length required.

While it is contemplated that other plastics or resins are available, or could be formulated to provide the required characteristics of low temperature ductility and extrudability, the inventor has successfully extruded Lexan™ EXL 1434 polycarbonate resin to form riser tubes. The manufacturer, General Electric Company's Advanced Materials, Plastics, division, in its product description, states this polycarbonate resin is for injection molding however the inventor has found that same can be successfully extruded.

The resulting riser tube remains ductile at low temperatures and is thus resistant to breaking. The riser tube can be bent over and will spring back to substantially its original shape. The riser tube of the invention is more resistant to damage than conventional PVC tubes. Especially in areas where conventional riser tubes require frequent replacement, the riser tube of the invention can provide a considerable economic benefit through reduced maintenance costs even though more initially costly than PVC tubes.

### DESCRIPTION OF THE DRAWING

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of a landscape irrigation sprinkler riser tube of the invention;

FIG. 2 is a side view of the tube of FIG. 1 installed in a typical landscape irrigation system;

FIG. 3 is an end view of the tube of FIG. 1.

### DETAILED DESCRIPTION OF THE ILLUSTRATED EMBODIMENT

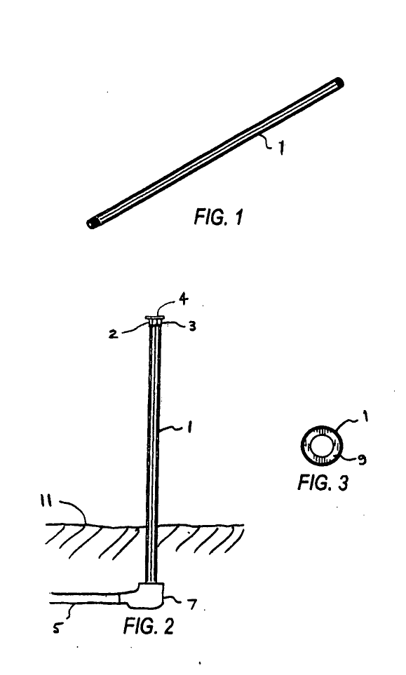

FIGS. 1-3 illustrate a riser tube 1 of the present invention comprising a hollow conduit that is threaded on each end to facilitate connection to an irrigation system. The illustrated riser tube 1, for example, is shown connected to a sprinkler head 3 at a top end thereof, and at the bottom end thereof to an underground supply hose 5 via an elbow 7.

While it is contemplated that other plastics or resins are available, or could be formulated to provide the required characteristics of low temperature ductility and extrudability, the inventor has successfully extruded Lexan™ EXL 1434 polycarbonate resin to form the riser tube 1. The manufacturer, General Electric Company's Advanced Materials, Plastics, division, in its product description, states this polycarbonate resin is for injection molding however the inventor has found that same can be successfully extruded to produce a riser tube at an economical cost.

The riser tube 1 can also be extruded to have a somewhat thicker wall 9, as illustrated in FIG. 3, than conventional riser tubes to provide added strength and resistance to breakage. A typical riser tube for example has an outside diameter of 0.84 inches, and an inside diameter of 0.51 inches and is threaded on the ends at ½ inch National Pipe Thread (NPT) to be used in a typical landscape irrigation system. The riser tube 1 of the invention can be extruded to have a reduced inside diameter between about 0.51 and 0.48 inches or less, thereby increasing the thickness of the wall 9 without adversely affecting the capacity of the riser tube 1 to supply sufficient water to the sprinkler head 3.

FIG. 2 illustrates a typical installation where the riser tube 1 extends from the elbow 7, located below ground level 11, to the sprinkler head 3 located well above the ground level 11. Typically the sprinkler head 3 will comprise an adapter 2 threaded onto the top of the riser 1 and a spray nozzle 4 threaded into the adapter. It is contemplated that the adapter could be injection molded from Lexan™ EXL 1434 polycarbonate resin material as well to resist damage in cold weather.

As with conventional riser tubes, the riser tube 1 is somewhat weaker at the threads because of the material removed when cutting the threads, however the riser tube is supported at ground level 11 by the surrounding soil such that the threads at the connection to elbow 7 are protected to a large extent from forces exerted on the upper portions of the riser tube. Especially in winter when the soil is frozen, a lateral force on the upper portion of the riser tube 1 will result in negligible forces at the elbow connection.

The characteristics of the Lexan™ EXL 1434 polycarbonate resin material used to make the riser tube 1 result in the riser tube remaining ductile at low temperatures and resistant to breakage. At higher summer temperatures the riser tube 1 is also rigid enough to maintain the sprinkler head 3 in the required orientation, and yet the riser tube will bend rather than break.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A riser tube for landscape irrigation comprising:
a substantially rigid hollow conduit, threaded at each end for attachment to an irrigation system;
wherein the hollow conduit is made by extruding a polycarbonate resin wherein the resin has a property of ductility at low temperatures.

2. The tube of claim 1 wherein the resin is stabilized against degradation by ultra-violet light.

3. The tube of claim 1 wherein the polycarbonate resin comprises Lexan™ EXL 1434 polycarbonate resin.

4. The tube of claim 1 wherein the hollow conduit has an outside diameter of about 0.84 inches, and an inside diameter of about 0.48 inches to 0.51 inches and is threaded on the ends at ½ inch National Pipe Thread (NPT).

5. The tube of claim 4 wherein the hollow conduit has an inside diameter of less than 0.50 inches.

6. A method of making a riser tube for landscape irrigation, the method comprising:
extruding a polycarbonate resin to form a hollow conduit;
cutting the hollow conduit to a desired length and threading at least one end of the desired length of hollow conduit;
wherein the resin has a property of ductility at low temperatures.

7. The method of claim 6 wherein the resin is stabilized against degradation by ultra-violet light.

8. The method of claim 6 wherein the polycarbonate resin comprises Lexan™ EXL 1434 polycarbonate resin.

9. The method of claim 6 wherein the hollow conduit has an outside diameter of about 0.84 inches, and an inside diameter of about 0.48 inches to 0.51 inches and is threaded on the ends at ½ inch National Pipe Thread (NPT).

10. The tube of claim 9 wherein the hollow conduit has an inside diameter of less than 0.50 inches.
